(19) United States
(12) Patent Application Publication
(10) Pub. No.: US 2021/0123850 A1
(43) Pub. Date: Apr. 29, 2021

(54) PREDICTION OF STATE VARIABLES FOR AIR FILTERS

(71) Applicant: Carl Freudenberg KG, Weinheim (DE)

(72) Inventors: Thomas CAESAR, Weinheim (DE); Karsten SCHULZ, Neckarbischofsheim (DE); Renate TAPPER, Bensheim (DE)

(21) Appl. No.: 17/069,880

(22) Filed: Oct. 14, 2020

(30) Foreign Application Priority Data
Oct. 25, 2019 (EP) 19 205 232.2

(51) Int. Cl. G01N 15/08; G06N 20/00; G06N 5/04

(52) U.S. Cl. CPC G01N 15/08; G01N 2015/084; G06N 5/04; G06N 20/00

(57) ABSTRACT

A method for predicting a change of at least one state variable, which characterizes a service life and/or performance of at least one air filter, includes the following steps: detecting at least one value of at least one influencing variable, on which the change in the at least one state variable per unit of time depends; detecting a time period for which the influencing variable having this value acts on the at least one air filter as a time duration; supplying the at least one value of the at least one influencing variable to at least one model which supplies an output quantity that is a measure for a contribution made to the change in the at least one state variable per unit of time that is caused by the at least one influencing variable; and determining the change of the at least one state variable.

### CROSS-REFERENCE TO PRIOR APPLICATION

Priority is claimed to European Patent Application No. EP 19 205 232.2, filed on Oct. 25, 2019, the entire disclosure of which is hereby incorporated by reference herein.

### FIELD

The invention relates to the planning and monitoring of the operation of air filters in industrial supply air filtration systems.

### BACKGROUND

Many industrial installations, such as gas turbines, compressors, and other turbo machines in which air is compressed, require large volumetric flows of supply air. In this case, there are frequently desires or requirements as to what maximum loading of the supply air with particles is permissible. Many types of particles can accumulate in the turbomachine over time (fouling) and thus alter the aerodynamics of turbine blades, which reduces efficiency and necessitates a regular cleaning of the turbomachine. Certain types of particles can also directly damage turbine blades due to mechanical erosion and/or chemical corrosion.

The “Supply air filtration” brochure of Arbeitsgemeinschaft für sparsamen and umweltfreundlichen Energieverbrauch e.V. (1991) describes the problem in detail and shows how the service life and efficiency of the turbomachine can be improved through the suitable design of a filtration system for the air supplied to the turbomachine.

Because the retained particles do not easily disappear, but instead accumulate in the filter arrangement or interact in some other way with the filter arrangement, air filters must be cleaned and/or changed in a suitable manner. This causes costs and downtimes of the installation supplied with the filtered supply air.

### SUMMARY

In an embodiment, the present invention provides a method for predicting a change of at least one state variable, which characterizes a service life and/or performance of at least one air filter, comprising the following steps: detecting at least one value of at least one influencing variable, on which the change in the at least one state variable per unit of time depends; detecting a time period for which the influencing variable having this value acts on the at least one air filter as a time duration; supplying the at least one value of the at least one influencing variable to at least one model which supplies an output quantity that is a measure for a contribution made to the change in the at least one state variable per unit of time that is caused by the at least one influencing variable; and determining the change of the at least one state variable from the output quantity and the time duration.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1: Exemplary embodiment of the method 100 for predicting a change 2a of a state variable 2;

FIG. 2: Exemplary embodiment of the method 200 for training a machine learning model 5; and

FIG. 3: Exemplary embodiment of the method 300 for identifying relevant influencing variables 3.

### DETAILED DESCRIPTION

In an embodiment, the present invention makes the cleaning or the change of filters in the supply air filtration better adapted to planning in such a way that the costs for these measures are optimized, while at the same time reducing the probability that unplanned maintenance work will be necessary.

In an embodiment, the present invention provides a method for predicting the change of at least one state variable as described herein, an associated training method for a machine learning model and an associated method for identifying relevant influencing variables as described herein and for a computer program as described herein. Further advantageous embodiments are described herein. Within the context of the invention, a method was developed for predicting a change in at least one state variable which characterizes the service life and/or performance of at least one air filter. The state variable may include in particular, for example, a loading state, and/or a pressure difference between the input and the output of the air filter which occurs when the air filter is operated, and/or a further variable influenced by the loading state or by the pressure difference.

In the method, at least one value of at least one influencing variable on which the change in the state variable per unit of time depends is detected. Furthermore, a time period for which the influencing variable acts on the air filter with this value is detected. The at least one value of the at least one influencing variable is supplied to at least one model. The model provides an output quantity that is a measure for the contribution, caused by the at least one influencing variable, to the change in the state variable per unit of time. The change in the state variable is determined from the output quantity and the time duration.

Both influencing variables and state variables are not limited to real-value quantities, but can also be complex-values or vector-values, for example.

A model is generally understood to mean a relationship, for example a functional relationship, which describes a dependence of the output quantity on one or more influencing variables, which is at least phenotypically consistent with the physical laws within the air filter leading from one or more influencing variables to the output quantity. As a rule, a model includes a more or less pronounced simplification or abstraction of these physical laws. The degree of this simplification or abstraction depends on the one hand on the required accuracy with which the model must reflect the physical laws and on the other hand on the effort required for (for example computational) handling.

The model may comprise, for example, one or more theoretically or empirically determined formulas, and/or one or more theoretically or empirically determined characteristic curves. For example, the dependence of the pressure difference between the input and the output of the air filter on many influencing variables can be approximately modeled by an exponential trend line. Alternatively or also in combination with this, the model may comprise, for example, a parameterized functional approach, the parameters of which can be adjusted accurately based on empirical knowledge by fitting, by training or in some other way, so that the approach reflects the said physical laws with sufficient accuracy.

However, the model does not necessarily have to be obtained from known functional relationships between influencing variables and state variables. Rather, the dependence of the state variables on the influencing variables can also be obtained by machine learning from characteristics of influencing variables on the one hand and state variables on the other hand. But functional physical relationships then still act “in the background”, do not have to be known explicitly in order to be able to predict state variables from influencing variables.

It has been recognized that the rate of change of state variables characterizing the service life and/or performance of an air filter is highly dependent upon influencing variables acting on the air filter.

These influencing variables include static (i.e., constantly acting on the air filter) influencing variables, such as the position of the air filter in an arrangement of a plurality of air filters or also the altitude above sea level at which the air filter is installed. For example, the order of filter stages in an arrangement of a plurality of air filters affects which types of particles can reach which filter stage at all. The altitude above sea level has an effect on the density of the air conveyed through the air filter. Static factors define to some extent a base rate at which the state variable of the air filter progresses from the new or fresh state toward the next required cleaning, or to the next required replacement, of the air filter.

In addition, however, there are also many dynamic influencing variables which act on the air filter only for limited periods of time but during these periods push the state variable especially quickly towards the next required maintenance or to the next required replacement for this purpose. The sporadic effect of such influencing variables, if not specifically sought here, is difficult to discover but can nevertheless have a decisive influence on the remaining service life of the air filter. Thus, for example, the combination of a forest fire and a wind direction leading from the fire location to the installation location of the air filter can impinge the air filter in a very short time with a particle dose which the air filter otherwise receives in an entire year. Thus, a prediction based solely on static influencing variables would be invalid for the service life of the air filter with an impact.

Considering completely unpredictable events, such as forest fires, the method of prediction makes it possible to quantify the effect of a very inhomogeneous and temporally variable canon of influencing variables on the service life and/or on the performance of the air filter. The accuracy obtainable in this case is at least sufficient to be able to schedule, for example, pending maintenance measures in advance within the framework of the operational boundary conditions. In this way, the overall costs of these maintenance measures, which are made up of the costs for the work itself and the costs for the downtime of the installation supplied with the supply air, can be minimized.

In an especially advantageous embodiment, the influencing variable comprises one or more of the following variables:

the position of the air filter in an arrangement of a plurality of air filters (as previously explained);

parameters characterizing the installation in which the air filter is installed and/or the operational management of this installation. For example, airflow through a turbo machine may vary depending on the load condition;

the manner in which at least one location or area is used in the area surrounding the installation location of the air filter. For example, vehicles traveling along roads produce fine dust while agricultural areas release pollen at the particular blooming time;

Events and/or operations in at least one location or in an area. For example, harvesting swirls large amounts of dust in an agricultural area;

the emission rate of at least one particulate and/or gaseous substance of at least one emission source, such as an adjacent industrial installation or a fire, and in some cases the number and size distribution of the particles;

the ground and/or air temperature, and/or atmospheric humidity, at the installation location of the air filter, and/or in at least one other location or in at least one other area;

the wind direction and/or wind intensity at the installation location of the air filter, and/or in at least one other location or in at least one other area; and/or

the type and thickness of precipitates at the installation site of the air filter, and/or in at least one other location or in at least one other area.

In the planning of maintenance measures, for example, it can be taken into account that, for example, significantly more particles of certain types are washed out of the air in a rainy summer than in a dry summer, while on the other hand certain other types of particles are stirred up by the rain.

Alternatively or also in combination with values of the aforementioned influencing variables, values of variables can also be measured, for example, with which the aforementioned influencing variables are correlated, without the values of the influencing variables having to emerge directly and unambiguously therefrom. In this case, they may, in particular, be states which can be directly measured more easily than the influencing variables themselves. Thus, the operating state of the installation, which in turn is at least one factor for how much the air filter is loaded per unit of time, can be inferred, for example, from the energy consumption, from the vibrations and/or from the acoustics of an air supply system which contains the air filter.

In a further especially advantageous embodiment, a combination of values of physically cooperative influencing variables is supplied to the model. In this way, the prior knowledge of this physical interaction can be used to improve the accuracy of the prediction for the state variable.

The physical interaction may in particular be, for example:

an interaction of the formation and/or release of at least one particulate and/or gaseous substance with the conveying of this substance in the direction of the air filter by wind, and/or

an agglomeration of particles and/or another conversion of at least one substance transportable with the air in the direction of the air filter by atmospheric humidity, and/or

a chemical and/or physical interaction of two or more substances transportable with the air in the direction of the air filter.

The prediction of the state variable or its change can be used in many ways in order to coordinate maintenance measures within the framework of operational boundary conditions and to reduce the costs for this. In response to the predicted state variable, or the predicted change, meeting a predetermined criterion, various actions may be initiated individually or in combination. Furthermore, for example, the design and selection of a filtered air supply system, in particular by selecting the correct filters for the expected particle quantities and particle sizes, can be improved by using the prediction now available. The prediction thus makes it possible to act proactively in order thus to have to react less to unplanned occurrences.

For example, a point in time at which maintenance (such as cleaning) and/or replacement of the air filter is appropriate may be determined. This need not necessarily be the time at which the filter is completely depleted. If, for example, the filter exchange is expected to be required on a holiday, expensive holiday surcharges may be incurred for the corresponding work. It may then be more economical to perform the work several work days beforehand and thus “sacrifice” some of the remaining service life of the filter. Conversely, it may be useful, for example, to set the filter maintenance of a supply air filtration for a power plant turbine to a time period at which the power demand is lower in order to reduce the effects on the power grid and on the loss of service.

For example, an order process for the air filter and/or for at least one replacement part for the air filter can be triggered. In this way, it can be ensured that the air filter or the replacement part is really available at the point in time at which the maintenance is due or planned. It is precisely the older seldom required air filters and replacement parts for this that are not always immediately available at each location.

For example, the installation in which the air filter is installed can be activated with a trigger signal. This may have the aim in particular, for example, of adapting the operation of the installation to an already reduced performance of the air filter. It is also possible, for example, to throttle the air flow rate of the installation in order to delay the time at which the air filter is completely exhausted up to a point in time at which the maintenance causes less costs and/or fewer consequential effects on installation operation.

In a further especially advantageous embodiment, a trainable machine learning model is selected as model. A machine learning model is understood in particular to mean a model in which the functional dependence of the output quantity on the influencing variable is characterized by a function parameterized with adjustable parameters with a force for generalization. The machine learning model may in particular comprise, for example, at least one artificial neural network, ANN, and/or it may be such an ANN. The large force for generalization can be used to arrive at an appropriate prediction of the state variable after training of the machine learning model with a finite number of situations in which the influencing variables and the state variable are respectively known, even in previously unknown situations which were not the subject of the training.

The machine learning model may be trained in particular on the basis of observations of one or more influencing variables on the one hand and one or more state variables on the other hand during real operation. The invention therefore also relates to a method for training a trainable machine learning model for use in the method described above.

Within the framework of this method, at least one actual time characteristic of at least one state variable characterizing the service life and/or performance of at least one air filter is detected. Furthermore, at least one actual time characteristic of an influencing variable, on which the change in the state variable per time unit depends, is detected. For example, at an air filter, the progress of the pressure difference, and/or the progress of the loading with particulates, may be measured by any method.

One or more time derivatives of the actual characteristic of the state variable are formed. Parameters which characterize the behavior of the machine learning model are optimized in such a way that the machine learning model maps values from the actual time characteristic of one or more influencing variables according to a cost function (also called a loss function) onto values of the one or more time derivatives as accurately as possible. In the case of an ANN, the parameters may comprise, for example, weights with which the inputs supplied to a neuron or another computing unit are calculated for activating this neuron or this computing unit. The type of cost function makes it possible to adjust, in particular in a granular manner, how strongly which deviations of a time derivative (change) of the state variable predicted on the basis of one or more influencing variables are to be “penalized” by the actual time derivative of this state variable.

In this type of training, the machine learning model learns how influencing variables and combinations thereof affect the state variable. Ambiguities are resolved in that on average yield the least inconsistencies over all training data used. In this case, it is possible, in particular, to crystallize out which of the detected influencing variables have any appreciable influence at all on the time rate at which the state variable changes. The more training data available, the better the ambiguities can be resolved.

For example, if the training data includes only situations where an industrial installation adjacent to the installation location of the air filter is either at a standstill or performing production processes that emit both noise and particulate matter, the machine learning model may ascribe the resulting faster loading of the air filter to both noise and particulate emissions. On the other hand, if the training data additionally include situations in which it is quiet but nevertheless many particles are emitted, the machine learning model will properly correlate the faster loading of the air filter with the particle emission and no longer with the noise.

In this context, the term “capture” is not to be understood as limiting the fact that separate measurements of the respective magnitude have to be carried out. Influencing variables may, in particular, also be obtained from any other source. For example, information on weather conditions or pollen count may also be retrieved from weather services.

Furthermore, the influencing variables on the one hand and the state variable on the other hand do not have to be detected simultaneously. For example, the time characteristic of an influencing variable to be newly considered may in particular be subsequently obtained if it is subsequently found that, with the influencing variables taken into account so far, the characteristic of the state variable cannot yet be explained sufficiently accurately. For example, it can first of all be assumed that particles emitted by forest fires or an explosion may have played a role in the event of an unexpectedly rapid loading of an air filter.

The identification of those influencing variables which have a significant effect on the characteristic of the state variable may also precede the training of a machine learning model, and generally also the other setup of a (for example rule-based) model for predicting the state variable. If, for example, it is intended to set up an approximation formula for the dependence of the state variable on the influencing variables, then this work is significantly facilitated if the influencing variables that are in question at all have already been determined in advance with an automated method.

The invention therefore also relates quite generally to a method for identifying at least one influencing variable, on which the change in a state variable characterizing the service life and/or performance of at least one air filter depends.

Within the framework of this method, a candidate time characteristic of at least one candidate influencing variable is detected, wherein, as previously explained, “detecting” comprises acquisition from any source. Furthermore, an actual time characteristic of the state variable is detected.

A correlation measure is determined for correlation of changes in the actual time characteristic with changes in the candidate time characteristic. In response to the determined correlation measure satisfying a predetermined condition, the candidate influencing variable is identified as an influencing variable relevant for the state variable.

It does not have to be the task of the correlation measure to also already determine the specific dependence of the state variable on the influencing variable. A binary classification of which influencing variables are especially relevant is already an essential tool for the subsequent setup of a model, irrespective of whether this model includes, for example, a machine learning model, another parameterized model, an approximation formula or, for example, also a rule-based model.

Machine learning may in turn be used for each of the aforementioned steps for identifying at least one influencing variable. For example, said (binary) classification may be carried out using a classifier appropriately trained for this purpose.

In a further especially advantageous embodiment, changes in the actual time characteristic resulting from already known influencing variables are identified and at least partially suppressed. The search is then specifically focused on new influencing variables, in which it represents a new recognition of the extent to which they affect the state variable.

In general, any previously existing knowledge of the dependency of the state variable on certain influencing variables may be used in order to specifically search for new influencing variables the consideration of which further improves the prediction of the state variable.

For this purpose, in a further especially advantageous embodiment, a first time characteristic of the state variable is determined on the basis of a first model. This first model, which is already present, links one or more already known influencing variables to at least one contribution to the change in the state variable per unit of time. A first error measure is determined based on a comparison of the first time characteristic to the actual time characteristic of the state variable.

A second time characteristic of the state variable is determined based on a second model that links the candidate influencing variable to at least one contribution to the change in the state variable per unit of time. This contribution may be additively factored into the contributions of the already known influencing variables, or it may replace these contributions completely or partially. A second error measure is determined based on a comparison of the second time characteristic to the actual time characteristic of the state variable.

The correlation measure with respect to the candidate influencing variable is now determined based on a comparison of the first error measure to the second error measure. This correlation measure may in particular be better, the better the second error measure is compared to the first error measure. Thus, if the consideration of the candidate influencing variable improves the accuracy with which the state variable can be predicted, then there is much to be said for doing so.

The training of a machine learning model may be embodied in particular in the parameters which characterize the behavior of this machine learning model. Whoever possesses these parameters can use the machine learning model directly without having to train it beforehand. Therefore, a parameter set of parameters that characterize the behavior of a trained machine learning model and are obtained with the previously described training method is an independently salable product.

The methods may, in particular, be fully or partially implemented by computer. Thus, the invention also relates to a computer program having machine-readable instructions that, when executed on one or more computers, cause the computer or computers to execute one of the described methods. In this sense, control devices and embedded systems for supply air filtration systems, for systems for supporting the planning and/or operation of supply air filtration systems or for other technical devices are also to be regarded as computers, because they are likewise able to execute machine-readable instructions.

The invention also relates to a machine-readable data storage medium and/or to a download product with the parameter set, and/or to the computer program. A download product is a digital product which can be transmitted via a data network, i.e. can be carried out by a user of the data network and can be offered for sale, for example, in an online shop for immediate download.

Furthermore, a computer can be equipped with the computer program, with the machine-readable data storage medium or with the download product.

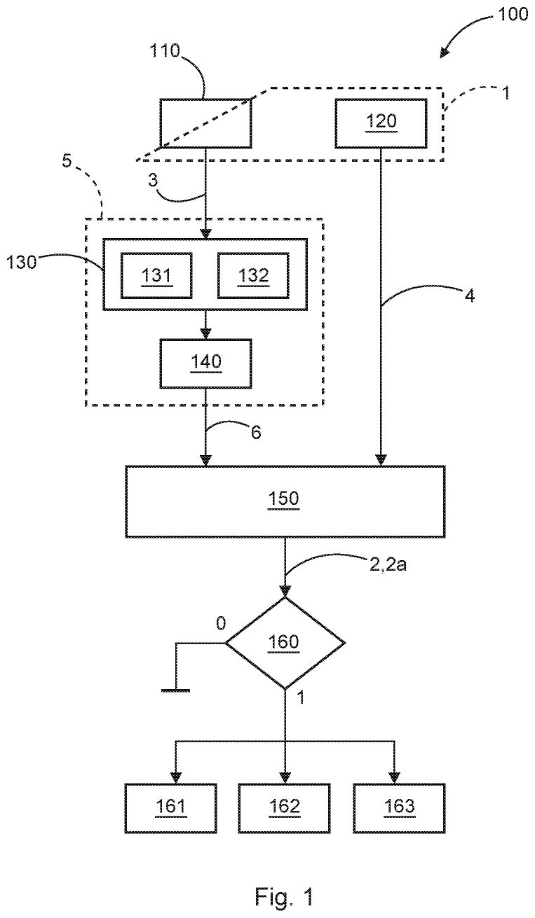

FIG. 1 is a flowchart of an exemplary embodiment of the method 100 for predicting a change 2a of a state variable 2 characterizing the service life and/or performance of at least one air filter.

In step 110, at least one value of at least one influencing variable 3 is detected. This value is fed to a model 5 in step 130, and the output quantity 6 supplied by the model 5 in step 140 is a measure for the contribution to the change in the state variable 2 per unit of time that is caused by the influencing variable 3.

In step 120, a time period for which the influencing variable 3 acts on the air filter is detected. As shown in FIG. 1 this can even take place parallel to the detection and processing of the influencing variable 3, but also before or after it. As previously explained, in addition to dynamic influencing variables 3, which act temporarily on the air filter 1, there may also be static influencing variables 3, which act permanently on the air filter 1.

In step 150, the sought change 2a in the state variable 2 is determined from the output quantity 6 and the time duration 4. This is the amount that the effect of the influencing variable 3 in the determined intensity “debits” from the “life account” of the air filter 1 during the time period 4. The accuracy with which the state of this “life account” can be predicted depends in particular on how often the composition and strength of the effective influencing variables 3 change and with what temporal granularity this is detected. If, for example, the influencing variable 3 is sampled at a fixed periodic time interval, this time interval defines the minimum time period 4 to which detected values of the influencing variables 3 can relate.

Two embodiments are shown within the box 130 by way of example. According to block 131, a combination of values of physically cooperating influencing variables 3 may be supplied to model 5 in order to utilize the prior knowledge of this interaction. At block 132, a trainable machine learning model may be selected as model 5.

In the example shown in FIG. 1, a check is made in step 160 as to whether the change 2a in the state variable 2 and/or the state variable 2 predicted on this basis meets a predetermined criterion. If this is the case (logical value 1), various measures can be implemented which are illustrated by way of example in FIG. 1. According to step 161, a point in time for maintenance (such as for cleaning) and/or a replacement of the air filter 1 may be determined. According to step 162 an ordering process may be initiated for at least one replacement part for the air filter 1. According to step 163, the installation in which the air filter 1 is installed may be activated with a trigger signal in order, for example, to delay the time at which maintenance or replacement of the air filter 1 is due.

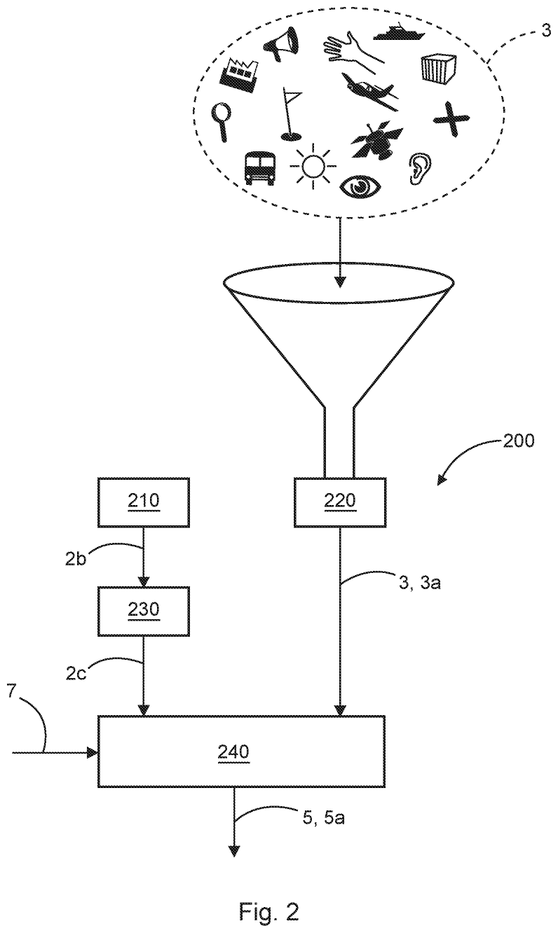

FIG. 2 is a flowchart of an exemplary embodiment of the method 200 for training a trainable machine learning model 5 with which the change 2a of a state variable 2 can then again be predicted.

In step 210, at least one actual time characteristic 2b of at least one state variable 2 characterizing the service life and/or performance of at least one air filter 1 is detected. From this, one or more time derivatives 2c are formed in step 230.

In step 220, at least one actual characteristic 3a of an influencing variable 3, on which the change in the state variable 2 per unit of time depends, is detected. As outlined in FIG. 2, there may be a very diverse canon of such influencing variables 3 which in part act independently of one another and in part interact with each other physically.

In step 240, the machine learning model 5 is trained by optimizing parameters 5a that characterize its behavior. This optimization is aimed at the objective of the machine learning model 5 mapping values from the actual time characteristic 3a of the influencing variables 3 as accurately as possible onto values of the one or more time derivatives 2c. It is also possible, in particular, to check, for example, whether a combination of values of a plurality of influencing variables 3 is mapped accurately onto the time derivatives 2c. The better the correspondence with the time derivatives 2c, the better the machine learning model 5 is able to predict a change 2a in the state variable 2. How good the match may be is evaluated based on the cost function (loss function) 7 established for training.

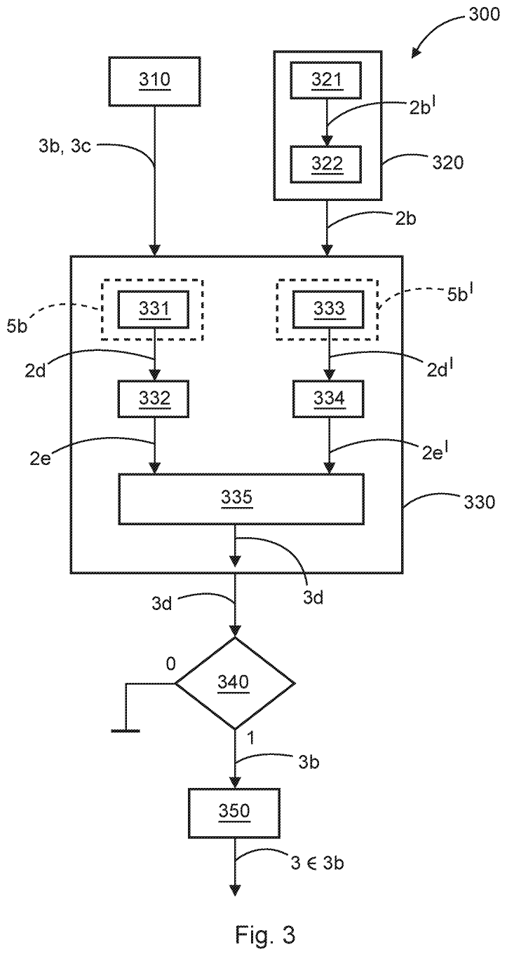

FIG. 3 is a flowchart of an exemplary embodiment of method 300 for identifying at least one influencing variable on which the change in state variable 2 depends. The state variable 2 characterizes the service life and/or performance of at least one air filter 1. The method 300 checks specific candidate influencing variables 3b as to whether they are relevant with respect to changes 2a in the state variable 2.

In step 310, a candidate time characteristic 3c of at least one candidate influencing variable 3b is detected. In step 320, an actual time characteristic 2b of the state variable 2 is detected. In step 330, a correlation measure 3d for correlation of changes in the actual time characteristic 2b with changes in the candidate time characteristic 3c is determined. In response to the determined correlation measure 3d meeting a predetermined condition 340, the candidate influencing variable 3b is identified as an influencing variable 3 relevant to the development of the state variable 2.

Within the box 320, an exemplary embodiment for detecting the actual time characteristic 2b of the state variable 2 is specified. According to block 321, changes 2b′ in the actual time characteristic 2b resulting from already known influencing variables 3 are identified. According to block 322, these changes 2b′ are at least partially suppressed. These changes 2b thus no longer occur, or only to a lesser extent, in the time characteristic 2b of the state variable 2.

Within box 330, an exemplary embodiment for determining correlation measure 3d is shown.

According to block 331, a first time characteristic 2d of the state variable 2 is determined based on a first model 5b. This first model 5b links one or more known influencing variables 3 to at least one contribution to the change in the state variable per unit of time. A first error measure 2e is determined based on a comparison of the first time characteristic 2d to the actual time characteristic 2b. This error measure indicates how well the actual time characteristic 2b of the state variable 2 can be predicted based on the first model 5b.

According to block 333, a second time characteristic 2d′ of the state variable is determined based on a second model 5b′. This second model links one or more candidate influencing variables 3b to at least one contribution to the change in the state variable 2 per unit of time. A second error measure 2e′ is determined based on a comparison of the second time characteristic 2d′ to the actual time characteristic 2b.

The correlation measure 3d is determined based on a comparison of the first error measure 2e to the second error measure 2e′. For example, this may include, in particular, that the more clearly the improvement of the error measure 2e′ achieved by taking into account the candidate influencing variable 3b, the better the correlation measure 3d precipitates.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 air filter
2 state variable characterizing the state of the air filter 1
2a change in the state variable 2
2b actual time characteristic of the state variable 2
2c time derivatives of the state variable 2
2d first time characteristic of the state variable 2 under known influencing variables 3
2d′ second time characteristic of the state variable 2 among candidate influencing variables 3b
2e first error measure under known influencing variables 3
2e′ second error measure under candidate influencing variable 3b
3 influencing variable, acts on state variable 2
3a actual time characteristic of the influencing variable 3
3b candidate influencing variable
3c candidate time characteristic of candidate influencing variable 3b
3d correlation measure of candidate time characteristic 3c with actual time characteristic 2b
4 time period for which influencing variable 3 acts on air filter 1
5 model for prediction of changes 2a
5a parameter, characterizing behavior of the model 5
5b first model based on known influencing variables 3
5b′ second model, takes into account candidate influencing variable 3b
6 output quantity, supplied by model 5
7 cost function for model 5 training
100 method for predicting a change 2a
110 detection of the influencing variable 3
120 detection of the time duration 4 for which the influencing variable 3 acts
130 supply of the influencing variable 3 to model 5
131 supply of cooperating influencing variables 3 as a combination
132 selection of a trainable machine learning model as model 5
140 generation of output quantity 6 by model 5
150 determination of change 2a from output quantity 6 and time duration 4
160 criterion for state variable 2 and/or change 2a
161 defining a point in time for maintenance of the air filter 1
162 triggering of an ordering process for replacement part
163 activation of the installation in which the air filter 1 is installed
200 method for training the machine learning model 5
210 detection of the actual time characteristic 2b of the state variable 2
220 detection of the actual time characteristic 3a of the influencing variable 3
230 formation of time derivatives 2c of the actual time characteristic 2b
240 optimization of the parameters 5a of the machine learning model 5
300 method for identifying relevant influencing variables 3
310 detection of the candidate time characteristic 3c of the candidate influencing variable 3b
320 detection of the actual time characteristic 2b of the state variable 2
330 formation of the correlation measure 3d
331 determination of the first time characteristic 2d with first model 5b
332 determination of the first error measure 2e from first time characteristic 2d
333 determination of the second time characteristic 2d′ with second model 5b′
334 determination of the second error measure 2e′ from the second time characteristic 2d′
335 determination of the correlation measure 3d from error measures 2e and 2e′
340 condition for correlation measure 3d
350 determination of the candidate influencing variable 3b as relevant influencing variable 3

What is claimed is:

1. A method for predicting a change of at least one state variable, which characterizes a service life and/or performance of at least one air filter, comprising the following steps:
detecting at least one value of at least one influencing variable, on which the change in the at least one state variable per unit of time depends;
detecting a time period for which the influencing variable having this value acts on the at least one air filter as a time duration;
supplying the at least one value of the at least one influencing variable to at least one model which supplies an output quantity that is a measure for a contribution made to the change in the at least one state variable per unit of time that is caused by the at least one influencing variable; and
determining the change of the at least one state variable from the output quantity and the time duration.

2. The method according to claim 1, wherein the influencing variable comprises one or more of the following variables:
a position of the at least one air filter in an arrangement of a plurality of air filters;
parameters characterizing an installation in which the at least one air filter is installed and/or an operating regime of the installation;
a type of use of at least one location or an area surrounding the installation location of the at least one air filter;
events and/or operations in at least one location or in at least one area;
an emission rate of at least one particulate and/or gaseous substance of at least one emission source;
a ground and/or air temperature, and/or atmospheric humidity, at the installation location of the at least one air filter, and/or in at least one other location or in at least one other area;
a wind direction and/or wind intensity at the installation location of the at least one air filter, and/or in at least one other location or in at least one other area;
a type and thickness of precipitates at the installation site of the at least one air filter, and/or in at least one other location or in at least one other area.

3. The method according to claim 1, wherein a combination of values of physically cooperating influencing variables is supplied to the model.

4. The method according to claim 3, wherein the physical cooperating comprises:
an interaction of a formation and/or release of at least one particulate and/or gaseous substance with a conveying of the substance in a direction of the at least one air filter by wind, and/or
an agglomeration of particles and/or another conversion of at least one substance transportable with air in a direction of the at least one air filter by atmospheric humidity, and/or
a chemical and/or physical interaction of two or more substances transportable with air in a direction of the at least one air filter.

5. The method according to claim 1, wherein in response to the predicted state variable and/or the predicted change satisfying a predetermined criterion,
a time at which maintenance and/or replacement of the at least one air filter is sensible is determined;
an order process for the at least one air filter and/or for at least one replacement part for the at least one air filter is triggered; and/or
an installation in which the at least one air filter is installed is controlled by a control signal.

6. The method according to claim 1, wherein the model comprises a trainable machine learning model.

7. The method according to claim 6, wherein a method for training the trainable machine learning model comprises the steps of:
detecting at least one actual time characteristic of at least one state variable which characterizes a service life and/or performance of the at least one air filter;
detecting at least one actual time characteristic of an influencing variable, on which the change in the state variable per unit of time depends;
forming one or more time derivatives of the actual characteristic of the state variable;
optimizing parameters which characterize a behavior of the training machine learning model such that the trainable machine learning model maps values from an actual time characteristic of one or more influencing variables in accordance with a cost function as accurately as possible onto values of the one or more time derivatives.

8. A method for identifying at least one influencing variable on which a change in a state variable characterizing a service life and/or performance of at least one air filter depends, the method comprising the following steps:
detecting a candidate time characteristic of at least one candidate influencing variable;
detecting an actual time characteristic of the state variable;
determining a correlation measure for correlating changes in the actual time characteristic with changes in the candidate time characteristic;
in response to the determined correlation measure meeting a predetermined condition, identifying the candidate influencing variable as the influencing variable relevant for the state variable.

9. The method according to claim 8, wherein changes of the actual time characteristic resulting from already known influencing variables are identified and at least partially suppressed.

10. The method according to claim 8, wherein determining the correlation measure comprises:
determining a first time characteristic of the state variable based on a first model, which links one or more already known influencing variables to at least one contribution for changing the state variable per unit of time;
determining a first error measure based on a comparison of the first time characteristic to the actual time characteristic;
determining a second time characteristic of the state variable based on a second model, which links the candidate influencing variables to at least one contribution to the change of the state variable per unit of time;
determining a second error measure based on a comparison of the second time characteristic to the actual time characteristic; and
determining the correlation measure based on a comparison of the first error measure to the second error measure.

11. The method according to claim 1, wherein the state variable comprises a pressure difference occurring during operation of the at least one air filter and/or a degree of loading of the at least one air filter with at least one substance.

12. A parameter set, obtained by the method according to claim 7, of parameters which characterize a behavior of the trainable machine learning model.

13. A computer program comprising machine-readable instructions which, when executed on one or more computers, cause the computer or computers to execute the method according to claim 1.

14. A machine-readable data storage medium and/or download product comprising the parameter set according to claim 12.

15. One or more computers equipped with the parameter set according to claim 12, comprising:
a computer program comprising machine-readable instructions which, when executed on one or more computers, cause the computer or computers to execute a method for predicting a change of at least one state variable, which characterizes a service life and/or performance of at least one air filter, the method comprising the following steps:
detecting at least one value of at least one influencing variable, on which the change in the at least one state variable per unit of time depends;
detecting a time period for which the influencing variable having this value acts on the at least one air filter as a time duration;
supplying the at least one value of the at least one influencing variable to at least one model which supplies an output quantity that is a measure for a contribution made to the change in the at least one state variable per unit of time that is caused by the at least one influencing variable; and
determining the change of the at least one state variable from the output quantity and the time duration, and/or
a machine-readable data storage medium and/or a download product comprising the parameter set.

16. A machine-readable data storage medium and/or download product comprising the computer program according to claim 13.
